(19) United States
(12) Patent Application Publication
(10) Pub. No.: US 2017/0221630 A1
(43) Pub. Date: Aug. 3, 2017

(54) METHOD OF MANUFACTURING RARE EARTH MAGNET

(71) Applicant: TOYOTA JIDOSHA KABUSHIKI KAISHA, Toyota-shi (JP)

(72) Inventor: Kazuaki HAGA, Toyota-shi (JP)

(73) Assignee: TOYOTA JIDOSHA KABUSHIKI KAISHA, Toyota-shi (JP)

(21) Appl. No.: 15/414,945

(22) Filed: Jan. 25, 2017

(30) Foreign Application Priority Data
Jan. 28, 2016 (JP) 2016-014294

(51) Int. Cl. H01F 41/02; H01F 1/057

(52) U.S. Cl. CPC H01F 41/0266; H01F 1/0577

(57) ABSTRACT

A method of manufacturing a rare earth magnet includes (i) manufacturing a rare earth magnet precursor using a sintered compact which is obtained by sintering magnetic powder which is a rare earth magnet material; (ii) causing a modifying alloy to diffusively penetrate into the rare earth magnet precursor so as to manufacture the rare earth magnet; and (iii) causing the modifying alloy to diffusively penetrate into the rare earth magnet precursor by adhering a sheet material, in which alloy powder of the modifying alloy is dispersed in a thermoplastic resin, to a surface of the rare earth magnet precursor and performing a heat treatment on the sheet material.

### INCORPORATION BY REFERENCE

The disclosure of Japanese Patent Application No. 2016-014294 filed on Jan. 28, 2016 including the specification, drawings and abstract is incorporated herein by reference in its entirety.

### BACKGROUND

1. Technical Field

The present disclosure relates to a method of manufacturing a rare earth magnet.

2. Description of Related Art

Rare earth magnets made from rare earth elements are called permanent magnets and are used for driving motors of hybrid vehicles, electric vehicles, and the like as well as motors included in hard disks and MRIs.

As an index indicating magnet performance of these rare earth magnets, for example, residual magnetization (residual magnetic flux density) and coercive force may be used. Along with a decrease in the size of a motor and an increase in current density, the amount of heat generation increases, and thus the demand for high heat resistance has further increased in rare earth magnets to be used. Accordingly, one of the important research issues in this technical field is how to hold the coercive force of a magnet when used at a high temperature. A Nd—Fe—B magnet which is a rare earth magnet widely used in a vehicle driving motor will be described as an example. In this Nd—Fe—B magnet, an attempt to increase the coercive force thereof has been made, for example, by refining crystal grains, by using an alloy composition having a large amount of Nd, or by adding a heavy rare earth element such as Dy or Tb having high coercive force performance.

Examples of the rare earth magnets include commonly-used sintered magnets in which a grain size of crystal grains constituting a structure thereof is about 3 to 5 μm; and nanocrystalline magnets in which crystal grains are refined into a nano grain size of about 50 nm to 300 nm.

In order to improve the coercive force among magnetic properties of such a rare earth magnet, International Publication WO2012/036294 discloses a method in which, for example, a Nd—Cu alloy or a Nd—Al alloy is caused to diffusively penetrate into a grain boundary phase as a modifying alloy containing a transition metal element and a rare earth element (or a light rare earth element) to modify the grain boundary phase.

Since the modifying alloy containing a transition metal element and a light rare earth element does not contain a heavy rare earth element such as Dy, the modifying alloy has a low melting point, is melted even at about 700° C., and can be caused to diffusively penetrate into the grain boundary phase. Accordingly, in the case of nanocrystalline magnets having a grain size of about 300 nm or less, it can be said that the above processing method is preferable because coercive force performance can be improved by modifying the grain boundary phase while suppressing the coarsening of crystal grains.

A method of manufacturing a rare earth magnet is performed using a method including: performing hot plastic deformation on a sintered compact to manufacture a rare earth magnet precursor to which magnetic anisotropy is imparted; and causing a modifying alloy to diffusively penetrate from the surface to the inside of the rare earth magnet precursor.

For the diffusion penetration of the modifying alloy, for example, a dipping method of dipping a rare earth magnet precursor in molten modifying alloy, or a vapor method of depositing vapor of a modifying alloy on a rare earth magnet precursor may be adopted.

For example, Japanese Patent Application Publication No. 2011-129648 (JP 2011-129648 A) discloses a technique using a dipping method including: dipping a magnet in a slurry including an element for improving coercive force such that the element is deposited on a surface of the magnet; and applying heat such that the element is melted and diffusively penetrates into the magnet.

On the other hand, Japanese Patent No. 4924547 discloses a technique using a vapor method including: putting an element for improving coercive force and a magnet in a vacuum chamber; and applying heat to vaporize the element; and causing the vaporized element to diffusively penetrate into the magnet.

### SUMMARY

However, in the dipping method and the vapor method, it is significantly difficult to cause a predetermined amount (designed amount) of a modifying alloy to diffusively penetrate into a rare earth magnet precursor with high accuracy, and the diffusion penetration amount is likely to be determined in the course of nature.

The disclosure provides a method of manufacturing a rare earth magnet in which a desired amount of a modifying alloy is caused to diffusively penetrate into a rare earth magnet precursor with high accuracy such that a rare earth magnet having desired coercive force performance can be manufactured.

An aspect of the disclosure relates to a method of manufacturing a rare earth magnet. The method comprises (i) manufacturing a rare earth magnet precursor using a sintered compact which is obtained by sintering magnetic powder which is a rare earth magnet material; (ii) causing a modifying alloy to diffusively penetrate into the rare earth magnet precursor so as to manufacture the rare earth magnet; and (iii) causing the modifying alloy to diffusively penetrate into the rare earth magnet precursor by adhering a sheet material, in which alloy powder of the modifying alloy is dispersed in a thermoplastic resin, to a surface of the rare earth magnet precursor and performing a heat treatment on the sheet material.

The sheet material contains a predetermined amount (designed amount) of the modifying alloy, and by performing the heat treatment on the sheet material, the predetermined amount of the modifying alloy is melted and is caused to diffusively penetrate into the rare earth magnet precursor. Therefore, the diffusion penetration amount of the modifying alloy can be easily controlled with high accuracy. Further, by preparing the large sheet material and cutting the prepared sheet material in a predetermined dimension, the amount of the powder of the modifying alloy in the sheet material can be controlled with high accuracy, and the diffusion penetration amount can be controlled with high accuracy.

In addition, in the sheet material, the modifying alloy is dispersed in the thermoplastic resin. Therefore, there is no interference in a case where, during the heat treatment, the thermoplastic resin is melted and the molten modifying alloy diffusively penetrates into the rare earth magnet precursor. On the other hand, in a normal temperature atmosphere, the shape of the sheet material can be maintained. Further, since the modifying alloy is dispersed in the thermoplastic resin, the oxidation of the modifying alloy is prevented.

Here, as the modifying alloy to be used, a modifying alloy containing a transition metal element and a light rare earth element may be used due to a low melting point or a low eutectic temperature thereof. Examples of the modifying alloy containing a transition metal element and a light rare earth element and having a melting point or an eutectic temperature in the above-described temperature range of 450° C. to 700° C. include an alloy containing a light rare earth element such as Nd or Pr and a transition metal element such as Cu, Mn, In, Zn, Al, Ag, Ga, or Fe. Not only an alloy containing a light rare earth element and a transition metal element but also an alloy containing a heavy rare earth element such as Dy or Tb and a transition metal element may be used.

On the other hand, examples of the thermoplastic resin include polyethylene and polypropylene.

For example, a method of preparing the sheet material may have an embodiment in which the sheet material is prepared by preparing a block body in which alloy powder of a rare earth element and a transition metal element is dispersed in a thermoplastic resin, drawing the block body to prepare a drawn body having a predetermined thickness, and cutting the sheet material from the drawn body, the sheet material having an area which corresponds to an area of the surface of the rare earth magnet precursor into which the modifying alloy penetrate.

In this method of preparing the sheet material, the thickness of the sheet material may be set by drawing the block body, which is the precursor of the sheet material, such that the sheet material includes a predetermined amount of the modifying alloy, the sheet material being cut to have an area corresponding to the area of the surface of the rare earth magnet precursor into which the modifying alloy is modified.

Here, the rare earth magnet which is a manufacturing target of the manufacturing method according to the disclosure may be a nanocrystalline magnet in which a grain size of a main phase (crystal) constituting a structure thereof is about 300 nm or less, may be a nanocrystalline magnet having a grain size of more than 300 nm, or may be a sintered magnet having a grain size of 1 μm or more.

The method of manufacturing a rare earth magnet will be described in more detail. Magnetic powder which has structure including a main phase and a grain boundary phase is prepared. For example, magnetic powder for a rare earth magnet is prepared by preparing a quenched ribbon, which is fine crystal grains, by liquid quenching and then, for example, crushing the quenched ribbon.

This magnetic powder is filled into, for example, a die and is sintered while being compressed by a punch to be bulked. As a result, an isotropic sintered compact is obtained. For example, this sintered compact has a metallographic structure that includes a RE-Fe—B main phase (RE: at least one of Nd or Pr, more specifically, one element or two or more elements selected from Nd, Pr, Nd—Pr) of a nanocrystalline structure and a grain boundary phase of an RE-X alloy (X: metal element) present around the main phase.

Next, hot plastic deformation may be performed on the isotropic sintered compact to impart magnetic anisotropy thereto. Examples of the hot plastic deformation include upset forging and extrusion forging (forward extrusion forging and backward extrusion forging). A processing strain is introduced into the sintered compact by using one method or a combination of two or more methods among the above-described hot plastic deformation methods. Next, for example, plastic deformation is performed at a processing rate of 60% to 80%. As a result, a rare earth magnet precursor having high orientation and superior magnetization performance is manufactured.

The sheet material including the modifying alloy is adhered to the surface of the rare earth magnet precursor, and a heat treatment is performed thereon. Due to this heat treatment, the thermoplastic resin which is the matrix resin of the sheet material is melted, the modifying alloy in the resin is melted, and the molten modifying alloy is caused to diffusively penetrate through the grain boundary phase of the rare earth magnet precursor. As a result, a rare earth magnet is manufactured.

As can be seen from the above-described configuration, in the method of manufacturing a rare earth magnet according to the present disclosure, the sheet material in which the modifying alloy is dispersed in the thermoplastic resin is adhered to the surface of the rare earth magnet precursor, and a heat treatment is performed thereon such that the modifying alloy is melted and diffusively penetrate into the rare earth magnet precursor. As a result, a desired amount of a modifying alloy can be caused to diffusively penetrate into a rare earth magnet precursor with high accuracy such that a rare earth magnet having desired coercive force performance can be manufactured.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing a method of preparing magnetic powder which is used in a method of manufacturing a rare earth magnet according to the disclosure;

FIG. 2 is a schematic diagram showing a first step of the method of manufacturing a rare earth magnet according to the disclosure;

FIG. 3 is a schematic diagram showing the first step of the method of manufacturing a rare earth magnet after FIG. 2;

FIG. 4A is a diagram showing a microstructure of a sintered compact shown in FIG. 2;

FIG. 4B is a diagram showing a microstructure of a rare earth magnet precursor shown in FIG. 3;

FIG. 5 is a schematic diagram showing a second step of the method of manufacturing a rare earth magnet after FIG. 3;

FIG. 6A is a schematic diagram showing an embodiment of a method of preparing a sheet material;

FIG. 6B is a schematic diagram showing the embodiment of the method of preparing a sheet material;

FIG. 6C is a schematic diagram showing the embodiment of the method of preparing a sheet material;

FIG. 7 is a diagram showing a microstructure of a manufactured rare earth magnet;

FIG. 8 is a diagram showing the results of an experiment for verifying a variation in the coating weight of a modifying alloy; and

FIG. 9 is a diagram showing the results of an experiment for verifying unevenness in the maximum coating thickness of a modifying alloy.

### DETAILED DESCRIPTION OF EMBODIMENTS

Hereinafter, an embodiment of a method of manufacturing a rare earth magnet according to the disclosure will be described with reference to the drawings.

(Embodiment of Method of Manufacturing Rare Earth Magnet)

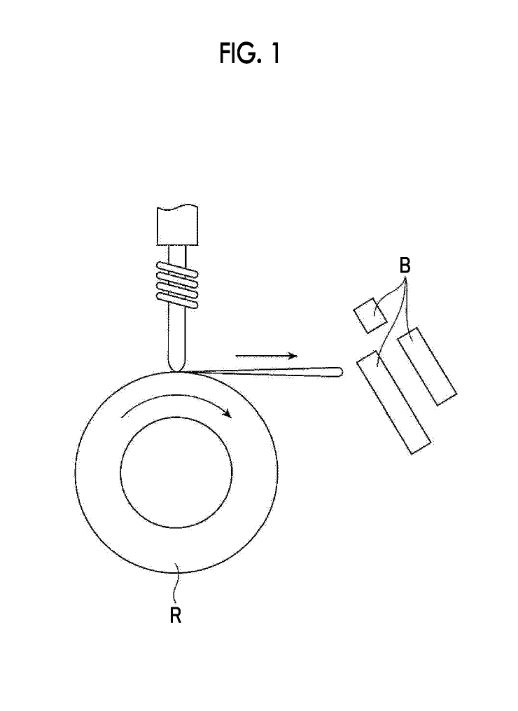

First, as shown in FIG. 1, in a furnace (not shown) of an Ar gas atmosphere in which the pressure is reduced to, for example, 50 kPa or lower, an alloy ingot is melted by high-frequency induction heating using a single-roll melt spinning method, and molten metal having a composition of a rare earth magnet is injected to a copper roll R to prepare a quenched ribbon B, and this quenched ribbon B is crushed to prepare magnetic powder.

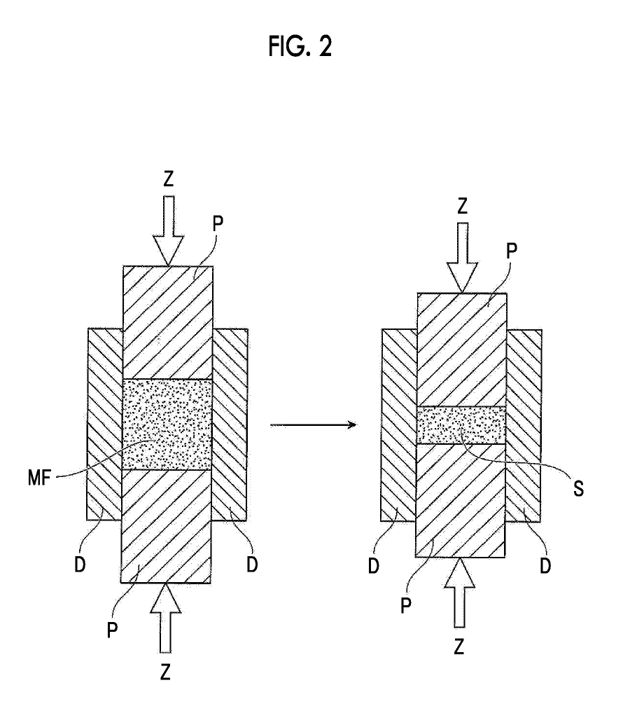

As shown in FIG. 2, the prepared magnetic powder MF is filled into a cavity which is partitioned by a cemented carbide die D and a cemented carbide punch P sliding in a hollow portion of the cemented carbide die D. The magnetic powder is electrically heated by causing a current to flow in a compression direction while being compressed with the cemented carbide punch P (Z direction). As a result, a sintered compact S is manufactured. This sintered compact S has a metallographic structure that includes a RE-Fe—B main phase (RE: at least one of Nd or Pr, more specifically, one element or two or more elements selected from Nd, Pr, Nd—Pr) and a grain boundary phase of an RE-X alloy (X: metal element) present around the main phase. The main phase has a grain size of about 50 nm to 300 nm.

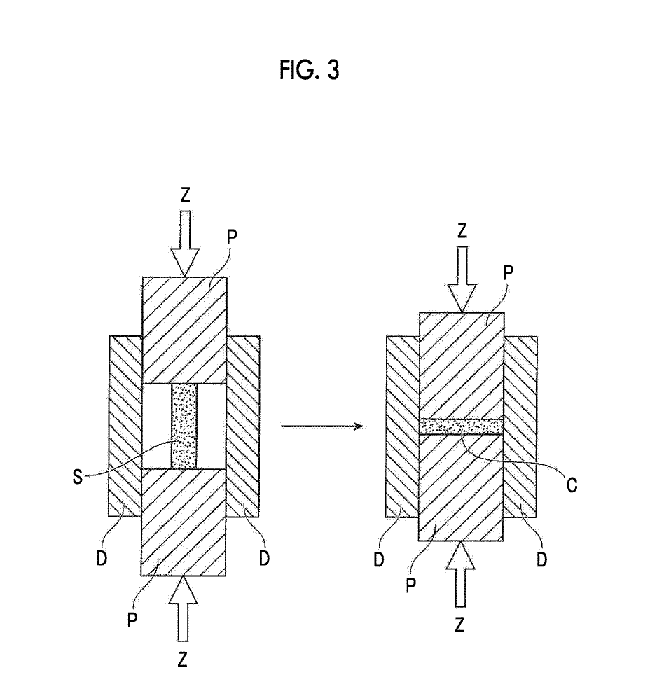

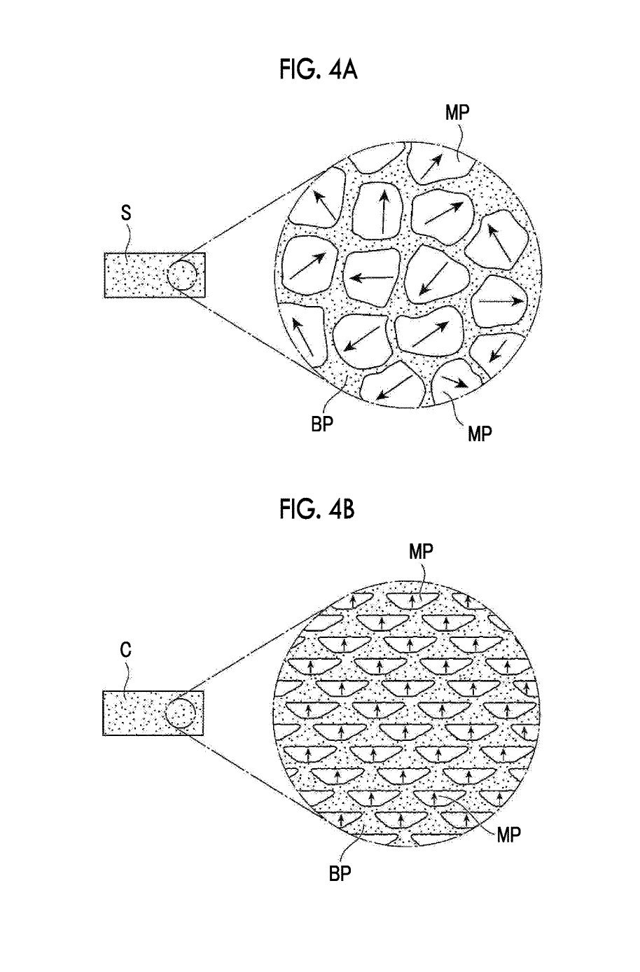

As shown in FIG. 4A, the sintered compact S has an isotropic crystal structure in which the grain boundary phase BP is filled between nanocrystalline grains MP (main phase). In order to impart magnetic anisotropy to the sintered compact S, as shown in FIG. 3, the cemented carbide punch P is brought into contact with an end surface of the sintered compact S in a longitudinal direction thereof (on the right drawing of FIG. 2, the horizontal direction is the longitudinal direction) such that hot plastic deformation is performed on the sintered compact S while being compressed with the cemented carbide punch P (Z direction). As a result, a rare earth magnet precursor C which includes a crystal structure having the anisotropic nanocrystalline grains MP as shown in FIG. 4B is manufactured.

The processing degree (compressibility) by the hot plastic deformation may be, for example, 10% or higher. It is preferable that plastic deformation is performed at a compressibility of about 60% to 80%. In a case where the compressibility is about 10% or higher, this processing may be called hot deformation or simply plastic deformation.

In a crystal structure of the rare earth magnet precursor C shown in FIG. 4B, the nanocrystalline grains MP have a flat shape, and the boundary surface which is substantially parallel to an anisotropic axis is curved or bent and is not configured of a specific surface (hereinabove, a first step).

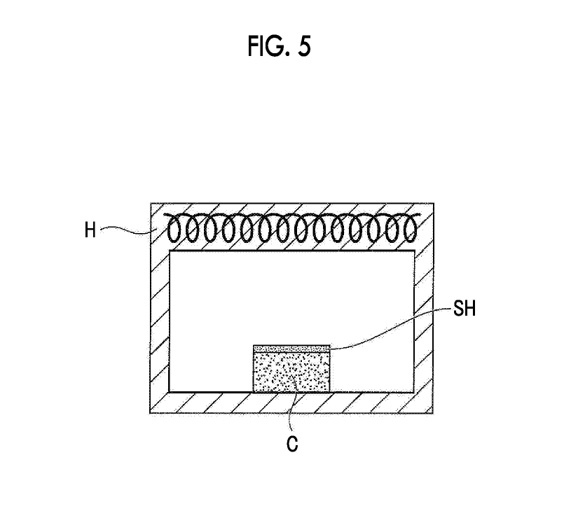

Next, as shown in FIG. 5, the rare earth magnet precursor C is put into a high-temperature furnace H. A sheet material SH, in which alloy powder of a rare earth element and a transition metal element is dispersed in a thermoplastic resin, is adhered to a surface of the rare earth magnet precursor C, and a heat treatment is performed thereon.

Due to this heat treatment, the thermoplastic resin which is the matrix resin of the sheet material SH is melted, the modifying alloy in the resin is melted, and the molten modifying alloy is caused to diffusively penetrate through the grain boundary phase of the rare earth magnet precursor C. As a result, a rare earth magnet is manufactured (hereinafter, a second step).

Here, the rare earth element, which constitutes the modifying alloy dispersed in the thermoplastic resin of the sheet material SH, may be a light rare earth element or a heavy rare earth element. It is preferable that the rare earth element is a light rare earth element having a low melting point or a low eutectic temperature.

Examples of the modifying alloy containing a transition metal element and a light rare earth element and having a melting point or an eutectic temperature in the above-described temperature range of 450° C. to 700° C. include an alloy containing a light rare earth element such as Nd or Pr and a transition metal element such as Cu, Mn, In, Zn, Al, Ag, Ga, or Fe.

More specifically, one of a Nd—Cu alloy (eutectic point: 520° C.), a Pr—Cu alloy (eutectic point: 480° C.), a Nd—Pr—Cu alloy, a Nd—Al alloy (eutectic point: 640° C.), a Pr—Al alloy (eutectic point: 650° C.), a Nd—Pr—Al alloy, a Nd—Co alloy (eutectic point: 566° C.), a Pr—Co alloy (eutectic point: 540° C.), and a Nd—Pr—Co alloy is preferably used as the modifying alloy having a low eutectic point of 450° C. to 700° C. Among these, one of alloys having a low eutectic point of 580° C. or lower, for example, a Nd—Cu alloy (eutectic point: 520° C.), a Pr—Cu alloy (eutectic point: 480° C.), a Nd—Co alloy (eutectic point: 566° C.), and a Pr—Co alloy (eutectic point: 540° C.) is preferably used.

In addition, in a case where the rare earth element is a heavy rare earth element, examples of the modifying alloy include an alloy containing a heavy rare earth element such as Dy or Tb and a transition metal element such as Cu, Mn, In, Zn, Al, Ag, Ga, or Fe.

On the other hand, examples of the thermoplastic resin which is the matrix resin of the sheet material SH include polyamide, polyester, polyphenylene sulfide, polyolefin, polyether ether ketone, polyethylene, polypropylene, methacryl resin, and a polyimide resin.

The sheet material SH contains a predetermined amount (designed amount) of the modifying alloy. By performing the heat treatment on the sheet material SH, a predetermined amount of the modifying alloy is melted and is caused to diffusively penetrate into the rare earth magnet precursor C. As a result, the diffusion penetration amount of the modifying alloy can be easily controlled with high accuracy. Therefore, a rare earth magnet having desired coercive force performance can be manufactured.

In addition, in the sheet material SH, the modifying alloy is dispersed in the thermoplastic resin. Therefore, there is no interference in a case where, during the heat treatment, the thermoplastic resin is melted and the molten modifying alloy diffusively penetrates into the rare earth magnet precursor C. On the other hand, in a normal temperature atmosphere, the shape of the sheet material SH can be maintained. Further, since the modifying alloy is dispersed in the thermoplastic resin, the oxidation of the modifying alloy is prevented.

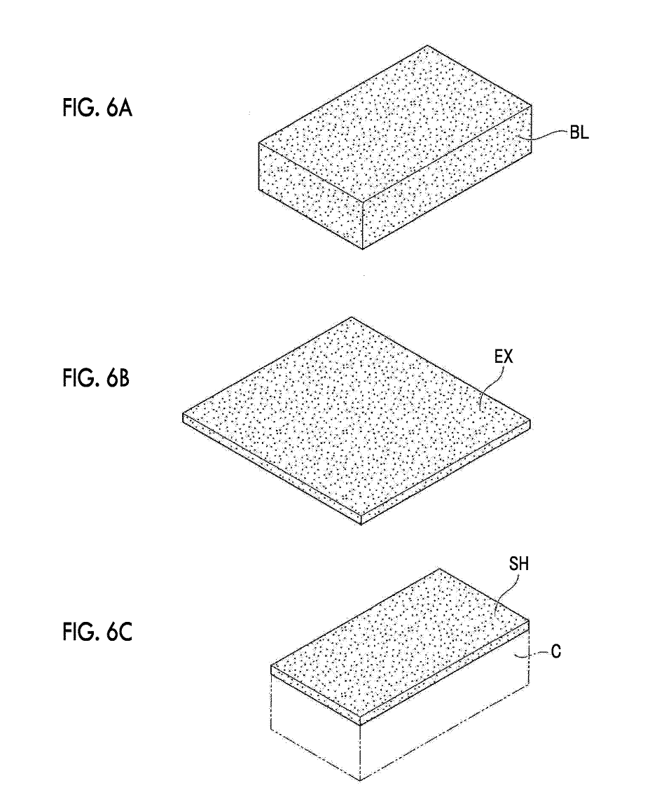

Further, an embodiment of a method of a preparing the sheet material will be described with reference to FIGS. 6A to 6C.

First, as shown in FIG. 6A, a block body BL is prepared in which alloy powder of a rare earth element and a transition metal element is dispersed in a thermoplastic resin.

Next, as shown in FIG. 6B, the block body BL is drawn to prepare a drawn body EX having a predetermined thickness.

By drawing the block body BL to prepare the drawn body EX as described above, a variation in the modifying alloy depending on positions of the block body BL can be reduced.

Next, as shown in FIG. 6C, the sheet material SH is cut from the drawn body EX, the sheet material SH having an area which corresponds to an area of the surface of the rare earth magnet precursor C into which the modifying alloy penetrate.

For example, in a case where the weight of the rare earth magnet precursor C is 159.6 g and the designed amount of the modifying alloy (Nd—Cu) for diffusion penetration is 10 mass % (15.96 g), the preparation of the drawn body EX and the cutting of the sheet material SH from the drawn body EX (the preparation of the sheet material SH) are performed such that the sheet material SH contains 15.96 g of the modifying alloy.

The manufactured rare earth magnet RM has a crystal structure shown in

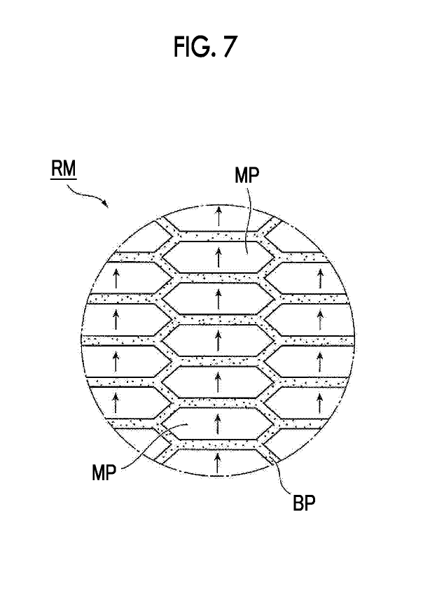

FIG. 7 and has a high coercive force. Accordingly, the crystal structure of the rare earth magnet precursor C shown in FIG. 4B is changed, the boundary surface of the crystal grains MP is cleared as shown in FIG. 7, the crystal grains MP are magnetically isolated from each other, and the rare earth magnet RM having an improved coercive force is manufactured. In an intermediate step of the structure modification by the modifying alloy shown in FIG. 5, a boundary surface which is substantially parallel to an anisotropic axis is not formed (is not configured of a specific surface). However, in a step in which the modification by the modifying alloy sufficiently progresses, a boundary surface (specific surface) which is substantially parallel to an anisotropic axis is formed, and the rare earth magnet RM in which the shape of the crystal grains MP is rectangular or substantially rectangular when seen from a direction perpendicular to the anisotropic axis is manufactured.

(Experiment for Verifying Variation in Coating Weight of Modified Alloy, Experiment for Verifying Unevenness in Maximum Coating Thickness of Modified Alloy, and Results Thereof)

The present inventors performed an experiment for verifying a variation in the coating weight of a modifying alloy and an experiment for verifying unevenness in the maximum coating thickness of a modifying alloy.

### EXAMPLE

Predetermined amounts of raw materials of a rare earth magnet were mixed with each other, and the mixture was melted in an Ar gas atmosphere. This molten alloy was injected to a Cu rotating roll plated with Cr through an orifice and then was rapidly cooled to prepare magnetic powder. The prepared ribbon was put into a forming die and was molded in an air atmosphere to obtain a compact. This compact was put into an INCONEL die having a different volume and was molded by hot compression molding in an air atmosphere to prepare a sintered compact. The obtained sintered compact was put into a forging die to perform hot plastic deformation thereon. As a result, a rare earth magnet precursor was prepared.

Next, the method of preparing the sheet material including the modifying alloy will be described. As the modifying alloy, an alloy having a composition of 70Nd—30Cu was used. Polypropylene was heated to a temperature of higher than or equal to 170° C. as a melting point in inert gas to be melted. The powder of 70Nd—30Cu was added to the molten polypropylene such that the volume ratio was 50:50, and the mixture was stirred while maintaining the temperature. As a result, a slurry was prepared. This slurry was cooled while cast into a die having a thickness 5.0 mm and a width of 100.0 mm. As a result, a block body was prepared.

This block body was heated to a temperature in a range of a melting point of polypropylene to a softening point of polypropylene and was drawn until a required thickness was applied by equally applying tension thereto horizontally and vertically. As a result, a drawn body was prepared. During this drawing, the block body was drawing to prepare the drawn body such that the diffusion penetration amount of the Nd—Cu alloy into the rare earth magnet precursor (that is, the amount of the Nd—Cu alloy for diffusion penetration with respect to the weight of the rare earth magnet precursor) was 0.25% and such that the thickness of the Nd—Cu alloy was 0.025 mm in the drawn body, that is, the thickness of the drawn body (sheet material) was 0.05 mm.

This drawn body was cut into a sheet material having an area of 30 mm×70 mm which was the area of the rare earth magnet precursor. The prepared sheet material was adhered to the surface of the rare earth magnet precursor, and a heat treatment was performed thereon such that the modifying alloy was melted and was caused to diffusively penetrate into the rare earth magnet precursor. As a result, a rare earth magnet having a dimension of 30 mm×70 mm×10 mm (thickness) and a weight of 159.6 g was prepared.

### COMPARATIVE EXAMPLE

Powder of 70Nd—30Cu was added to an acrylic resin in inert gas such that the volume ratio was 50:50, and the mixture was stirred. As a result, a slurry was prepared. The rare earth magnet precursor prepared using the same method as in Example was dipped in the prepared slurry such that the slurry was adhered to the surface of the rare earth magnet precursor, and a heat treatment was performed thereon. As a result, a rare earth magnet having a dimension of 30 mm×70 mm×10 mm (thickness) and a weight of 159.6 g was prepared.

(Experiment Result 1)

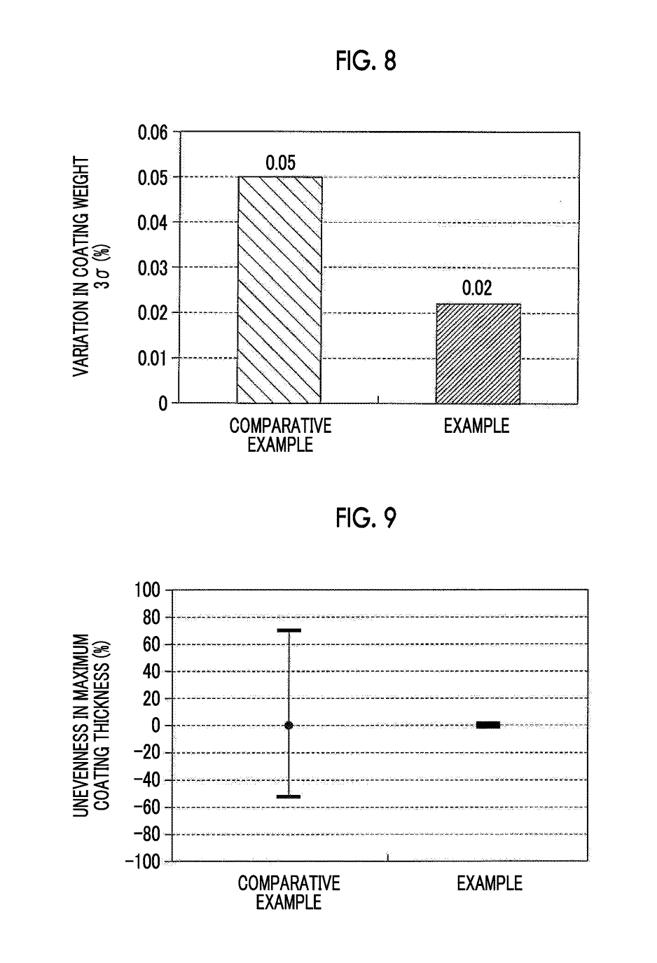

FIG. 8 shows the results of a variation 3σ in the coating weight of the modifying alloy in each of Example and Comparative Example.

The variation in the coating weight was calculated by measuring the weight before and after the coating based on the results of “the number N of specimens=30”.

It was verified from FIG. 8 that, in Example, the variation in the coating weight was reduced to be half or less of that in Comparative Example.

In Comparative Example, the coating was performed by dipping the rare earth magnet precursor in the slurry and then pulling the rare earth magnet precursor up. Therefore, the coating amount of the slurry depends on, for example, the speed of pulling the rare earth magnet precursor up or the surface state of the rare earth magnet precursor (for example, the cleanliness of the surface). Therefore, it is significantly difficult to manage the coating amount, and it is presumed that the variation in the coating amount increases.

On the other hand, in Example, it is only necessary to manage the cutting dimension of the drawn body. Therefore, it is presumed that the variation in the coating amount is reduced.

(Experiment Result 2)

FIG. 9 shows the results regarding the unevenness in the maximum coating thickness of the modifying alloy in each of Example and Comparative Example.

The unevenness in the maximum coating thickness is defined as a difference between a maximum value and a minimum value of the slurry thickness measured after the coating.

It was verified from FIG. 9 that, in Example, the unevenness in the maximum coating thickness can be reduced significantly as compared to Comparative Example.

The biggest factor was the use of the sheet material in which the modifying alloy is dispersed. In a case where the sheet material is used, the thickness can be made to be uniform. On the other hand, in a case where the dipping method is used as in Comparative Example, for example, a large amount of the slurry was adhered to an end portion of the rare earth magnet precursor, and the amount of the slurry adhered to the center of the rare earth magnet precursor is reduced. In this way, there is no means for controlling the unevenness in the coating thickness, and it is presumed that the unevenness in the coating thickness occurs due to the above-described reason.

In addition, in the embodiment, since the modifying alloy is dispersed in the thermoplastic resin, the oxidation of the modifying alloy can be prevented. In addition since the sheet material can be prepared in advance, it is not necessary to prepare a slurry whenever the modifying alloy is caused to diffusively penetrate into the rare earth magnet precursor. In addition, since the method of adhering the sheet material to the rare earth magnet precursor is used, a predetermined amount of the modifying alloy can be caused to diffusively penetrate into any rare earth magnet precursor having any shape or into a predetermined position of the rare earth magnet precursor.

Hereinabove, the embodiments of the disclosure have been described with reference to the drawings. However, a specific configuration is not limited to the embodiments, and design changes and the like which are made within a range not departing from the scope of the disclosure are included in the disclosure.

What is claimed is:

1. A method of manufacturing a rare earth magnet, the method comprising:
manufacturing a rare earth magnet precursor using a sintered compact which is obtained by sintering magnetic powder which is a rare earth magnet material; and
causing a modifying alloy to diffusively penetrate into the rare earth magnet precursor so as to manufacture the rare earth magnet;
causing the modifying alloy to diffusively penetrate into the rare earth magnet precursor by adhering a sheet material, in which alloy powder of the modifying alloy is dispersed in a thermoplastic resin, to a surface of the rare earth magnet precursor and performing a heat treatment on the sheet material.

2. The method according to claim 1, wherein
the sheet material is prepared by preparing a block body in which alloy powders of a rare earth element and a transition metal element are dispersed in the thermoplastic resin, drawing the block body to prepare a drawn body having a predetermined thickness, and cutting the sheet material from the drawn body, the sheet material having an area which corresponds to an area of the surface of the rare earth magnet precursor into which the modifying alloy penetrate.

3. The method according to claim 1, wherein
the modifying alloy contains either one light rare earth element of Nd or Pr and at least one transition metal element selected from a group of Cu, Mn, In, Zn, Al, Ag, Ga, and Fe.

4. The method according to claim 1, wherein
the thermoplastic resin contains at least one selected from the group consisting of polyamide, polyester, polyphenylene sulfide, polyolefin, polyether ether ketone, polyethylene, polypropylene, methacryl resin, and a polyimide resin.
